(19) United States
(12) Patent Application Publication
(10) Pub. No.: US 2018/0084881 A1
(43) Pub. Date: Mar. 29, 2018

(54) Mobile Device Protective Case with Accessory Berth

(71) Applicant: Kalyx Designs, LLC, Queen Creek, AZ (US)

(72) Inventor: Jeffrey Muench, Queen Creek, AZ (US)

(73) Assignee: Kalyx Designs, LLC, Queen Creek, AZ (US)

(21) Appl. No.: 15/712,819

(22) Filed: Sep. 22, 2017

Related U.S. Application Data
(60) Provisional application No. 62/398,396, filed on Sep. 22, 2016.

(51) Int. Cl. A45C 11/00; H02J 7/00

(52) U.S. Cl. CPC A45C 11/00; H02J 7/0044; H02J 2007/005; A45C 2011/002; A45C 2011/003; H02J 7/0047

(57) ABSTRACT

A mobile device protective case in accordance with various embodiments can comprise an accessory berth. An accessory berth can be configured to receive and secure a mobile electronic device accessory such as a wireless ear bud or other accessory.

### FIELD

The present disclosure relates to protective cases for mobile electronic devices. More specifically, the present disclosure relates to protective cases that include features configured to receive and secure one or more mobile electronic device accessories, such as wireless earphones.

### BACKGROUND

Mobile electronic devices such as smartphones are frequently used with accessories such as headphones, earbuds, movement sensors, and other types of devices that transmit information to and from the smartphone. While many such accessories have traditionally relied on a wired connection to the phone, such as via a jack inserted into a receptacle in the phone, accessories that rely on various wireless communication technologies such as Bluetooth and Wi-Fi are increasingly common. Moreover, the continued evolution electronic systems components has generally resulted in increased miniaturization of both mobile electronic devices and wirelessly connected electronic accessories. Such continued miniaturization can produce devices that are more fragile and/or more subject to loss due to misplacement. Therefore, protective cases that provide for protection of mobile electronic devices and accessories as well as retention of mobile electronic device accessories in physical association with the mobile electronic devices with which they are used are desirable.

### SUMMARY

In various embodiments, a mobile device case can comprise a first case portion and a second case portion. The first case portion can comprise a plurality of walls configured to define a front compartment configured to receive a mobile electronic device. A second case portion can comprise a plurality of surfaces defining an accessory berth area. The accessory berth area can comprise an accessory berth defined within the mobile device case and at least partially located within the accessory berth area. The accessory berth can be configured to receive a mobile device accessory. A mobile device accessory can comprise an elongated stem and a speaker portion attached to the elongated stem. An accessory berth can be configured to slidably receive a mobile device accessory. The mobile device case can comprise an accessory berth opening in a top surface of the case. A stem-receiving portion of an accessory berth can be comprise an ejection aperture adjacent a distal end of the stem-receiving portion configured to allow a user to slide an accessory inserted into the accessory berth out of the berth.

In various embodiments, a mobile device case can comprise a front compartment configured to receive a mobile device, an accessory berth configured to receive a mobile device accessory, and a charging system. A charging system can comprise a rechargeable power cell, a mobile device interface, an accessory charging interface, an external interface, and electronic circuitry. A rechargeable power can be embedded in a wall of the case. A mobile device interface can be configured to electrically couple the charging system to a mobile device inserted into the case. An accessory charging interface can be configured to electrically couple the charging system to a mobile device accessory inserted into an accessory berth. The external interface can be configured to electrically couple the charging system and an external power source. The electronic circuitry can be configured to electrically couple the rechargeable power cell and at least one of the mobile device interface, the accessory charging interface, and the external interface. The mobile device case can comprise a charge level indicator and a button configured to control a switch. The mobile device case can comprise an accessory berth aperture that is substantially hidden from view when the mobile device case is viewed from a front perspective.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates a front perspective view of a protective case in accordance with various embodiments;

FIG. 2 illustrates a rear perspective view of a protective case in accordance with various embodiments;

FIG. 3 illustrates a top view of a protective case in accordance with various embodiments;

FIG. 4 illustrates a bottom view of a protective case in accordance with various embodiments;

FIG. 5 illustrates a perspective view of a protective case in accordance with various embodiments;

FIG. 6 illustrates a cross section view of a protective case in accordance with various embodiments;

FIG. 7 illustrates a front view of a protective case in accordance with various embodiments;

FIG. 8 illustrates a rear view of a protective case in accordance with various embodiments;

FIG. 9 illustrates a profile view of a protective case in accordance with various embodiments;

FIG. 10A illustrates a front perspective view of a protective case in accordance with various embodiments; and

FIG. 10B illustrates a rear perspective view of a protective case in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical, and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

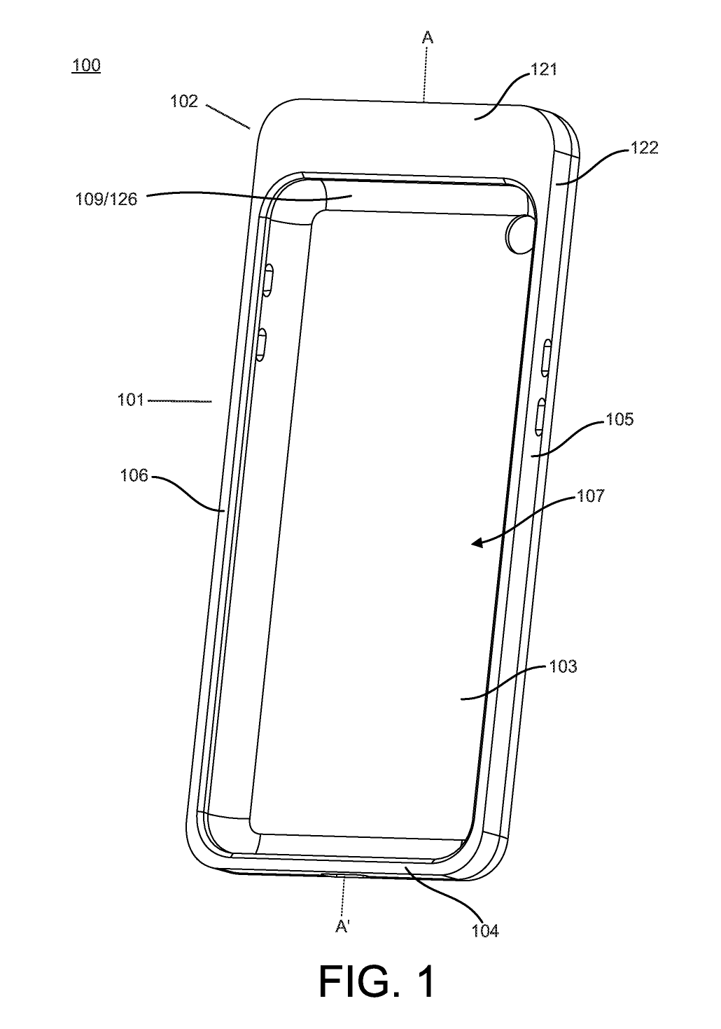

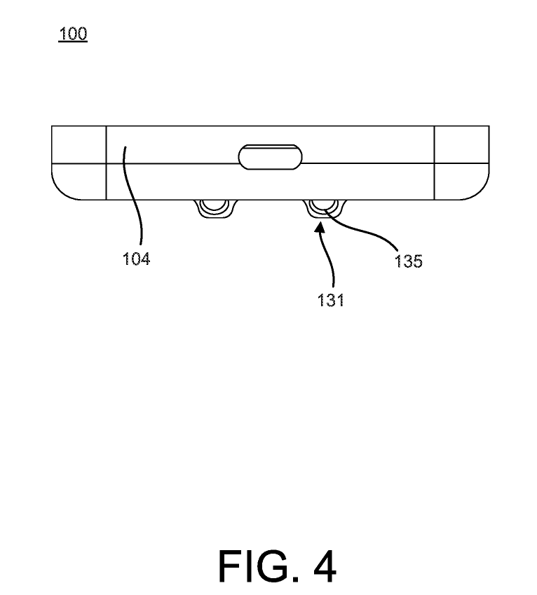

With reference now to FIGS. 1-4, a mobile device case 100 in accordance with various embodiments, is illustrated. Case 100 can comprise a first case portion 101 and a second case portion 102. First case portion 101 can comprise a front compartment 107 configured to receive a mobile electronic device. Front compartment 107 can be defined by a plurality of walls, including a back wall 103, a bottom wall 104, a first side wall 105, and a second side wall 106. The back wall can define a back wall rear surface 108. In various embodiments, front compartment 107 can further be defined by a top wall 109. Top wall 109 can comprise a portion of first case portion 101, or top wall 109 can comprise a portion of second case portion 102.

Front compartment 107 can be dimensionally sized to receive a mobile electronic device such as a smartphone, tablet, phablet, slate, or other mobile device. Bottom wall 104, first side wall 105, second side wall 106, and top wall 109 can extend substantially perpendicularly to back wall 103 at a distance approximately corresponding to the depth or thickness of a cell phone housing and can include an inwardly oriented lip extending toward the opposing wall to provide an opening dimension that is nominally undersized relative to the corresponding dimension of the cell phone housing to which the case is sized, thereby providing for a snap or friction fit suitable to positively retain a mobile device in the front compartment 107 after it has been inserted. In various embodiments, the dimensions of bottom wall 104, first side wall 105, second side wall 106, and top wall 109 may be configured such that when a cell phone is inserted into the front compartment, the front edge or surface of one or more of the walls may extend above the front surface of the inserted cell phone.

As used herein, the terms “front” and “back” (or “rear”) can refer to the front surface (i.e., the display panel) of a mobile electronic device and the back surface of the mobile electronic device, respectively. In addition, the term “peripheral edge” can refer to any of the four side surfaces of the mobile electronic device extending between the front and back surfaces. A display panel of a mobile electronic device can comprise a touch screen display, and the peripheral edge of the mobile electronic device can comprise a plurality of buttons and/or connectors situated about the periphery of the housing, such as a power or sleep/wake button, volume control buttons, charging jack port, ring/silent switch, and the like. A rear surface of the housing can also comprise one or more camera and/or flash lenses or other features.

A case in accordance with various embodiments can comprise a plurality of apertures situated in one or more of the plurality of walls and corresponding to each of the plurality of buttons, connectors, and or lenses of the mobile electronic device when the device is disposed within the front compartment. In various embodiments, a case can comprise one or more button protrusions dimensioned and configured to reside above or over a user control button on the mobile device such as a volume, power, mute, or other user button. A button protrusion can be resiliently deformable to permit operation of the underlying button through the button protrusion without requiring substantially greater force and without substantially decreasing the tactile feel or feedback of the underlying button during operation.

In various embodiments, a device described herein may be specifically dimensioned and configured for use with an iPhone® cell phone. Likewise, it should be readily apparent to a person of ordinary skill in the art that repositioning of the apertures and dimensionally resizing a device in accordance with various embodiments of the present disclosure could be performed to accommodate most any mobile device having similar design features, namely buttons and connectors about the periphery of the mobile device and a touch-screen user interface on the front side of the mobile device. Minor modifications to dimensions and aperture locations of the illustrated case could be made to produce functionally equivalent cases for other mobile devices such as those produced by manufacturers such as LG, Samsung, HTC, Google, Microsoft and the like.

In various embodiments, case 100 can comprise a second case portion 102. Second case portion can be located adjacent to first case portion 101, such as at a top end of first case portion 101. Second case portion 102 can comprise a plurality of surfaces, including a rear surface 124, a front surface 121, a first side surface 122, a second side surface 123, a top surface 125, and a bottom surface 126. The plurality of surfaces can define an accessory berth area that includes features suitable to receive and secure one or more mobile electronic device accessories, as described in greater detail below.

In various embodiments, second case portion 102 can be integrally joined to first case portion 101. For example, second case portion 102 can be permanently joined to first case portion 101, such as by welding or adhering the materials of the case portions. In various embodiments, case 100 can be integrally formed, such as by injection molding. Various materials that can be used for construction of a case in accordance with various embodiments are described in greater detail below. In various embodiments, a second case portion may be attached to a first case portion by mechanical means, for example, by a snap fit.

Case 100 can define a rectangular shape, with the long dimension of the case defining a case axis A-A′. Second case portion 102 can be located at an end of first case portion 101, thereby extending the length of case 100 in the direction of axis A-A′ and providing an accessory berth area adjacent to an end of the front compartment 107 defined by first case portion 101. Such a configuration may be suitable to provide mobile device case having an accessory berth area while minimizing the need for increasing the thickness of the case (i.e., in a front to rear dimension). In other embodiments, a case can be configured to provide an accessory berth area with an extension of the case in a dimension other than the length of the case, such as by an extension of the width or thickness of the case.

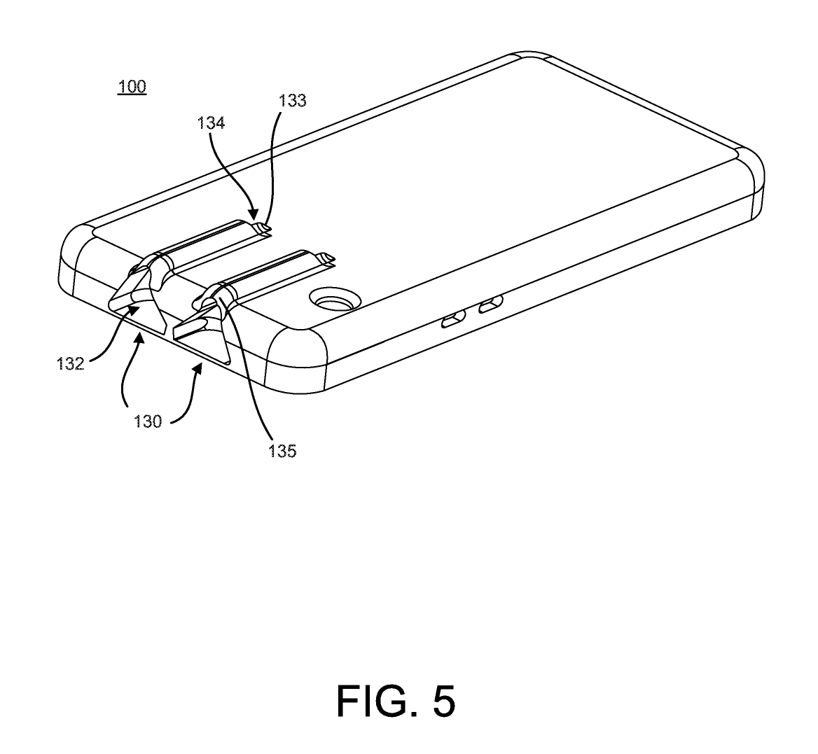

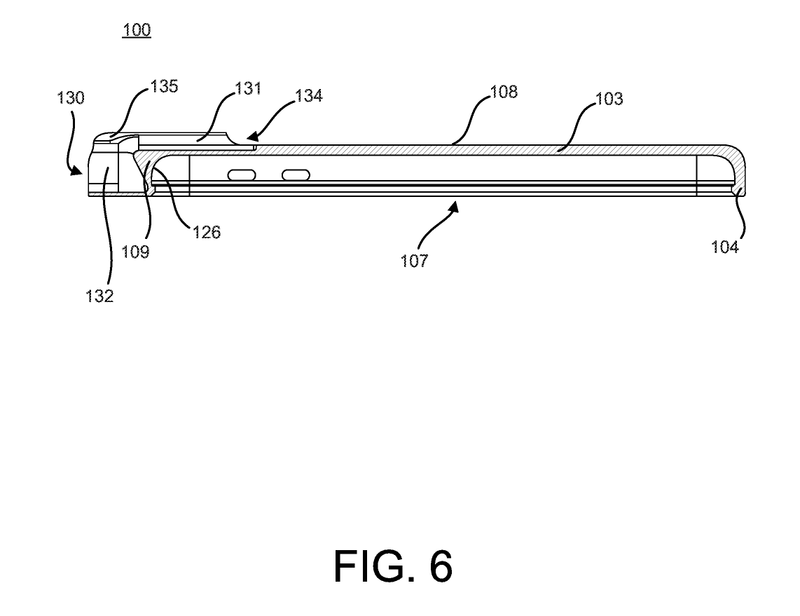

With continued reference to FIGS. 1-4, and with reference also to FIGS. 5 and 6, case 100 can comprise an accessory berth 130 defined by internal walls of second case portion 102 and/or other walls of case, as described in greater detail below. In various embodiments, a case can comprise a plurality of accessory berths 130, such as the pair of accessory berths depicted in the illustrated embodiment. An accessory berth 130 can be configured to receive and secure an accessory. By way of example, an accessory can comprise a particular wireless ear bud, such as an Apple AirPod device, and an accessory berth 130 can be dimensionally configured to slidably receive that particular device. An accessory such as an AirPod or similar wireless ear bud can comprise an elongated stem with a first end and a second end, the elongated stem defining a longitudinal axis. The accessory can further comprise a speaker portion attached to the elongated stem at the first end. Accessory berth 130 can comprise a stem-receiving portion 131 and a speaker-receiving portion 132 defined by surrounding walls molded in the accessory berth area. In various embodiments, the entirety of an accessory berth can be located within an accessory berth area, or a portion of an accessory berth may overlap with a first portion of a phone case, dimensionally overlapping with the front compartment when viewed from the front or rear of the case or from a right or left side of the case. In various embodiments, such as wherein the case is extended in a rear dimension of the case, substantially all of the accessory berth may overlap with the front compartment when viewed from the front or rear of the case.

In the illustrated embodiment, stem-receiving portion 131 of accessory berth 130 partially overlaps with the back wall 103 of first case portion 101. A portion of case 100 defining the rearward wall of stem-receiving portion 131 can partially protrude rearward from a plane defined by the back wall rear surface 108, such that stem-receiving portion 131 is partially defined by a semi-cylindrical groove in back wall 103. An end 133 of the groove can provide a positive-stop for insertion of the stem portion of an accessory. In various embodiments, the stem-receiving portion of an accessory berth can substantially overlap with the back wall of a first case portion, or can be substantially non-overlapping. The stem-receiving portion need not partially protrude from the back wall rear surface of a case, and in various embodiments, a stem receiving portion of an accessory berth can be located substantially within the body of the case, such that the stem receiving portion does not protrude from the primary surfaces defined by the walls of case, such as the back wall rear surface.

Stem-receiving portion 131 can further comprise an ejection aperture 134 adjacent to a distal end of the stem-receiving portion. The ejection aperture can be configured to expose a sufficient length and cross-section of an inserted accessory to permit a user to slide an inserted accessory out of the accessory berth using a fingertip. For example, profile of the aperture may expose an about 1 to about 4 mm section of the second end of the stem portion, such as about a 1 mm, or about a 2 mm, or about a 3 mm section, inclusive of any fractional portion of a mm dimension within the aforementioned range. Similarly, the length of the aperture may provide for a sufficient slide length during an ejection operation for the user to slide an inserted accessory a sufficient distance to overcome a retention lip 135 located at or near accessory berth aperture 136. For example, the length of the aperture may be between about 1 mm and about 10 mm, such as about 1 mm, about 2 mm, about 3 mm, about 4 mm, about 5 mm, about 6 mm, about 7 mm, about 8 mm, about 9 mm, about 10 mm, or any fractional portion of a mm dimension within the aforementioned range. In various embodiments, the length of the aperture may be configured in response to the configuration of an accessory retention feature, such that the length of the aperture is sized to provide sufficient ejection action travel to overcome the retention feature. In various embodiments, the ejection aperture may also be configured to provide sufficient exposure of an inserted accessory for manipulation and ejection of the accessory by a user while protecting the accessory from bumping or physically contacting a flat object surface, such as the surface of a table, if the rear face of the case is set on the surface with the accessory inserted in the accessory berth.

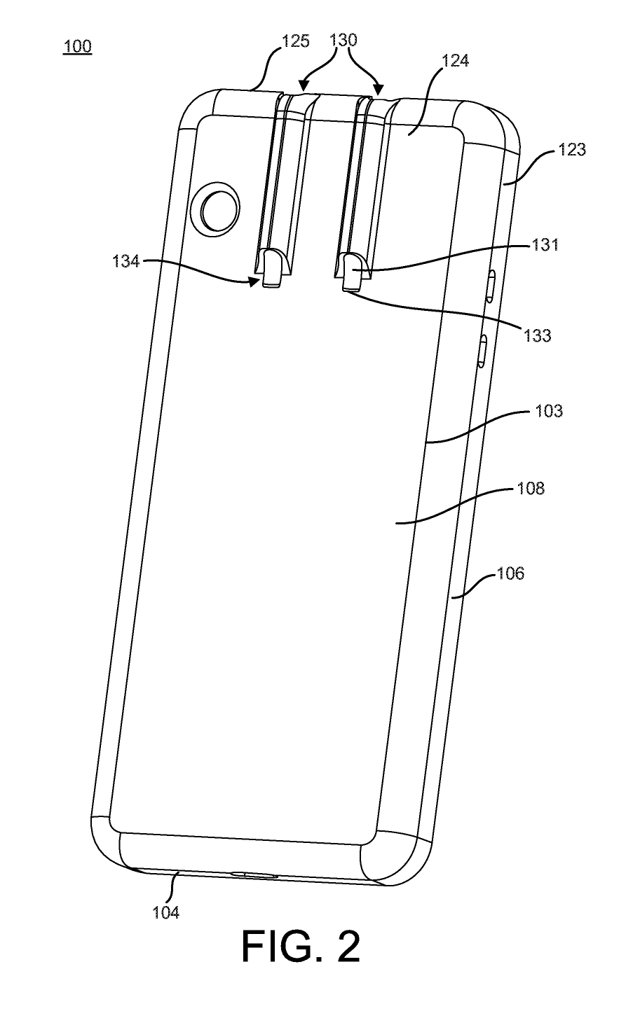

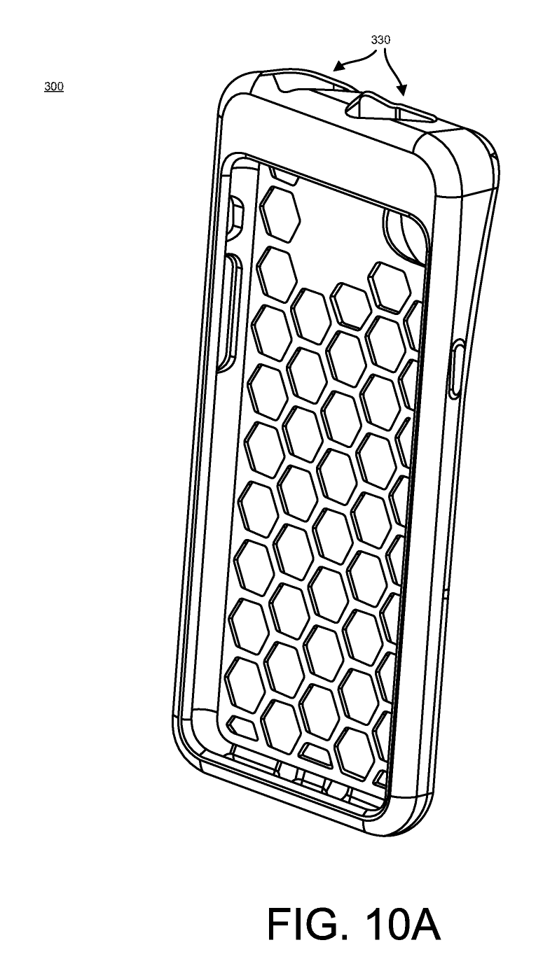

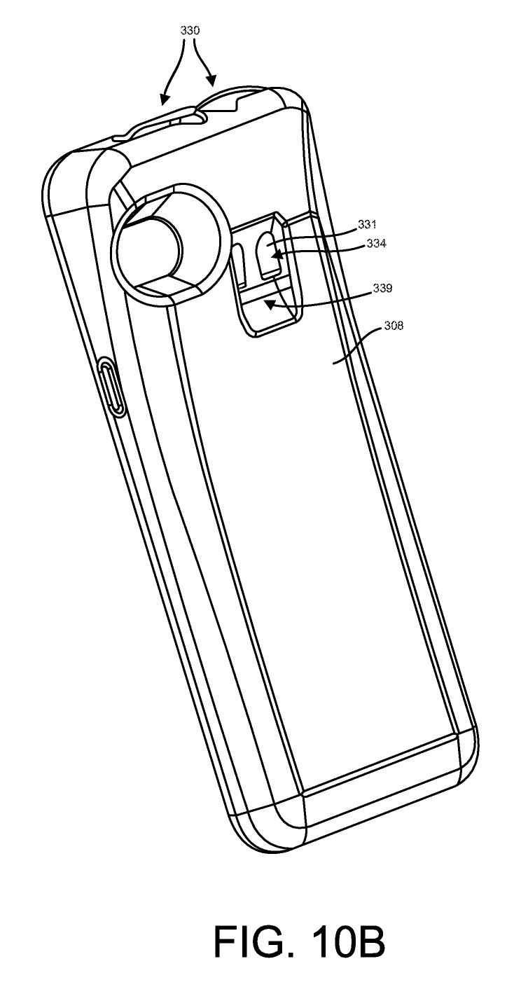

In various embodiments, and with reference briefly to FIGS. 10A and 10B, a mobile device case such as case 300 can comprise a configuration suitable to provide an accessory berth with walls that do not protrude from a plane defined by the primary surfaces of the case. For example, and as illustrated in FIG. 10B, back wall rear surface 308 of case 300 is configured to provide a sufficient thickness to case 300 in the region of the case comprising accessory berths 330 such that the stem-receiving portions 331 of accessory berths 330 do not protrude from the primary plane of back wall rear surface 308 (i.e., the stem-receiving portion 331 of accessory berths 330 are not visible when the case is viewed from the sides). Instead, a depression 339 is defined in the back wall rear surface 308 of case 300 to provide a user with an ejection aperture 334 adjacent to a distal end of stem-receiving portion 331 of accessory berths 330. Moreover, in the illustrated embodiment, accessories inserted into accessory berths 330 may be further protected from inadvertent physical contact with objects or features of surfaces on which case 300 may be placed or otherwise physically contacted, as compared to accessory berths 130 of case 100 (FIG. 2).

In various embodiments, an accessory berth need not comprise an ejection aperture. An accessory berth with a closed distal end can comprise an alternative ejection mechanism. For example, in various embodiments, a case can comprise a push-push type ejection mechanism. A push-push type mechanism is one in which, for example, an inwardly directed pushing force is impressed upon an mechanism bolt member in the open position so as to move the bolt member from its opened position to its closed position, whereupon a latch in the mechanism then maintains the bolt member at its closed position, and similarly, an inwardly directed pushing force may be subsequently impressed upon the closed and latched bolt member so as to initially unlatch or release the latch mechanism, whereupon the bolt member may be moved to its opened position.

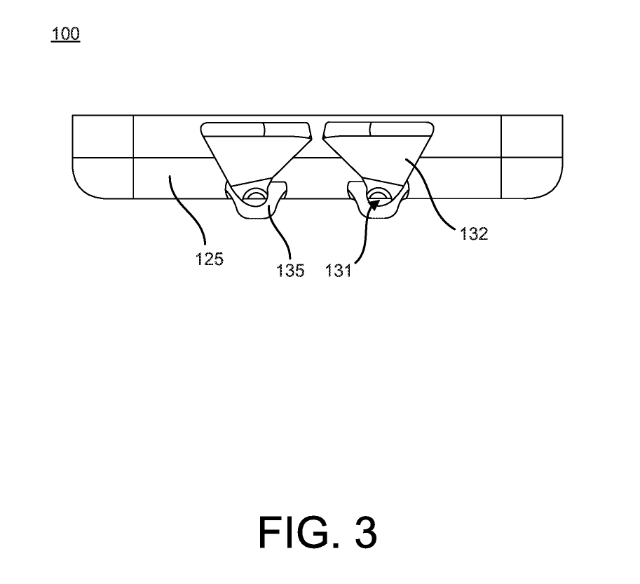

In various embodiments, the bolt travel and push force required to achieve release may be a short distance compatible with user operation via a manipulation of the inserted accessory by a user's fingertip (through or across the accessory berth aperture) while suitable to prevent accidental release, such as by contact with other objects in a pocket or purse. For example, the bolt travel may be between about 0.5 mm and about 5 mm, such as about 1 mm, or about 2 mm, or about 3 mm, or about 4 mm, or about 5 mm, or any fractional portion of a mm increment there between. The push force may be, for example, comparable to the force required to operate various buttons that may protrude from the peripheral edge of the phone, such as the sleep/wake button or the volume control buttons. An accessory berth comprising a push-push type of ejection mechanism can rely on a mechanical retention feature, such as retention lip 135 (FIGS. 3-6) or similar retention feature, as described above, with the ejection force of the mechanism providing the mechanical force to overcome the retention feature when actuated.

In various embodiments, a push-push type ejection mechanism can comprise a magnet suitable to provide a pull (retention) force on an accessory in contact with the mechanism. The pull force may be sufficient to retain the accessory in the accessory berth during normal user activity with the mechanism in the closed position. The pull force may be sufficient to retain an accessory in contact with the mechanism during an ejection process, such as a force greater than the mass of the accessory plus the force exerted by deceleration of the accessory at the end of the ejection process to maintain the accessory in contact with the mechanism following ejection (and thereby prevent the accessory from launching from the case during ejection). In various embodiments, a magnet can comprise, for example, a neodymium rare earth magnet or similar magnetic material suitable to provide sufficient magnetic pull force in a small form factor compatible with a streamlined cased design. In various embodiments, a case comprising a magnetic push-push type ejection mechanism can include both magnetic and mechanical (e.g., retention lip) retention features.

In various embodiments, a push-push type ejection mechanism can be configured with a damping mechanism to control the movement of the bolt member between the opened and closed positions. For example, a bolt member permitted to abruptly open relative to the case and/or an inserted accessory, the resulting forces between such components could cause damage to both components, and could also generate undesirable vibration and noise.

In various embodiments, a latch mechanism may be secured in the case, such as by a snap fit, adhesive, molded in place, threaded attachment, or other mechanical attachment.

In various embodiments and as illustrated with reference once again to FIGS. 1-6, a longitudinal axis of an accessory berth (such as the axis defined by the length of stem-receiving portion 131) may be substantially aligned with case axis A-A′. Accessory berth 130 can be configured to slidably receive an accessory via accessory berth aperture 136 by insertion of the second end of the stem portion of the accessory first, with the accessory berth aperture located in a top surface of the case or second case portion (i.e., the top end of the case) and insertion in a direction substantially aligned with the stem-receiving portion axis and case axis. In various embodiments, the accessory berth aperture may be substantially hidden from view when the case is viewed from the front. The accessory can be removed from the accessory berth by slidable ejection or removal in an opposite direction from that of insertion. Full insertion of an accessory can further comprise movement of the accessory in a second direction during an insertion action to overcome a retention feature such as retention lip 135, with an angular movement direction necessary for insertion of the speaker portion of an accessory into an accessory berth. In various embodiments, a retention feature such as retention lip 135 may be elastically deformable, and insertion and removal of an accessory into and out of the accessory berth can comprise displacement of the retention lip, with return of the retention feature to a substantially non-displaced position following insertion or removal. A retention feature can be located at or near an accessory berth aperture, or an accessory feature can be located elsewhere in the accessory berth. For example, a retention feature can comprise a protrusion on a wall defining the speaker-receiving portion of an accessory berth, the protrusion corresponding in location and dimensionally configured to fit within a recess of the accessory, such as a speaker port.

In various embodiments, an accessory berth can be oriented substantially perpendicularly to case axis A-A′, with accessory berth apertures on first side and/or second side surfaces of a case or second case portion. In such an embodiment comprising a pair of accessory berths, the accessory berth openings can be located in opposite sides of the case and the stem-receiving portions staggered from one another to minimize the additional area of a second case portion necessary to accommodate a pair of accessory berths.

In various embodiments, a case can comprise a charging system. A charging system can comprise a rechargeable power cell, electronic components, and electronic circuitry to provide an electronic connection between the power cell and/or various electronic components and/or a mobile device inserted in the case. In various embodiments, electronic components can include a mobile device interface, an external interface, a charge level indicator, a switch, an accessory charging interface, and the like. The mobile device interface can be adapted to provide power from at least one of the power cell and an external power source to a mobile device inserted in the case. The mobile device interface can be configured to pass signal to/from (i.e., electrically couple) the mobile device and at least one of the external interface and the power cell. The external interface can be configured to allow recharging of the power cell as well as passing signals to/from the mobile device via the mobile device interface. A switch may be operatively connected to an actuator such as a button or toggle that allows a user to manipulate the state of the switch and an electrical connection made by the charging system, such as between the power cell and the mobile device (i.e., toggling between “on” and “off” switch positions). A switch may be controlled manually by a user via an external actuator, such as a button configured to control the switch in response to a user depressing the button, or a switch may be controlled automatically based on the presence of a connected mobile device or accessory and/or the charge status of a connected device (i.e., a “smart” charging system). A charge level indicator can permit displaying the charge level of the power cell on an external surface of the case. An accessory charging interface can be configured to electrically couple the charging system to a mobile device accessory inserted into an accessory berth, thereby providing an ability to recharge an electronic accessory inserted into an accessory berth via an electrical connection to at least one of the power cell, the mobile device, and an external power source. The various charging system components described above can be electrically coupled in various combinations by electronic circuitry. Various components of the charging system described herein, other than an accessory charging interface, are known in the art, such as those described in U.S. Pat. No. 9,406,913, which reference is incorporated herein in its entirety.

In various embodiments, an accessory charging interface can be configured to charge an accessory via an electrical connection or by inductive electrical recharging system that does not requires direct contact or can recharge at a distance. Similarly, the case may be configured to allow inductive charging of the power cell.

In various embodiments, a power cell can be located in the second case portion that is unoccupied by an accessory berth. Alternately, a power cell can be located within the back wall of the first case portion, such as within the thickness of the back wall or in a compartment defined in the back wall. In various embodiments wherein the thickness of a power cell may be comparable to a dimension of an accessory berth (such as the minimum overall dimension of an accessory berth), substantially all of the accessory berth can overlap with the front compartment, and the dimension of the second case portion in the direction of axis A-A′ can be minimized, such as to a thickness equivalent to one of the side walls or the bottom wall. In such an embodiment, an accessory berth can be configured such that it does not protrude from a surface of the case. In various embodiments, the thickness of a power cell may be approximately or substantially the same as the thickness of the mobile communication device. For this purpose, a power cell may be slim and/or have a configuration that it does not significantly increase the thickness and/or size of a case in accordance with the present disclosure. Consequently, a mobile device can be conveniently used within the case since the power cell does not significantly increase the bulkiness of the mobile device.

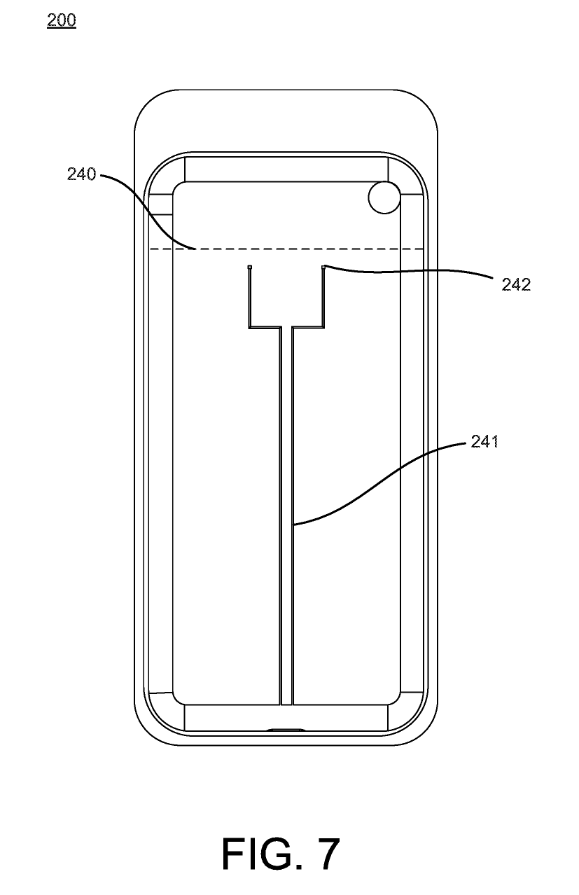

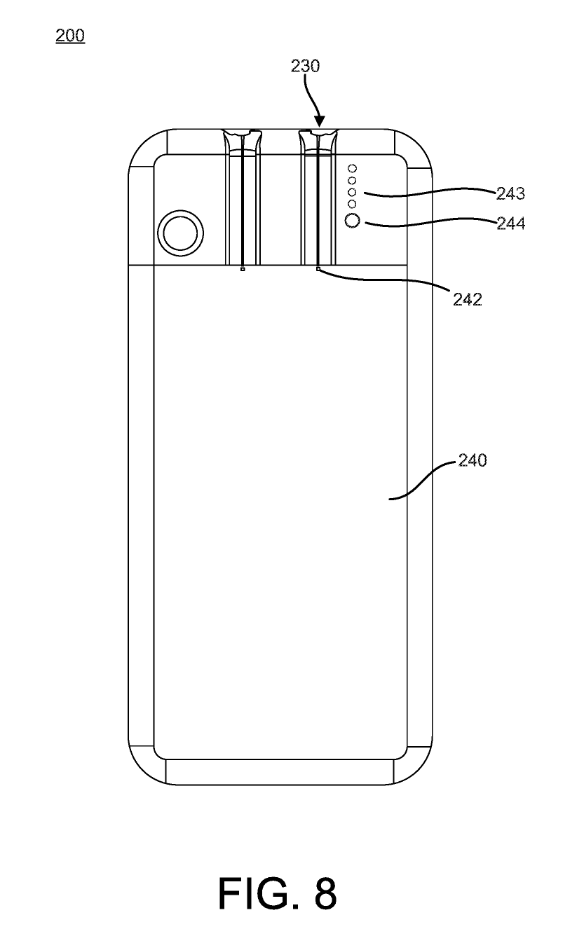

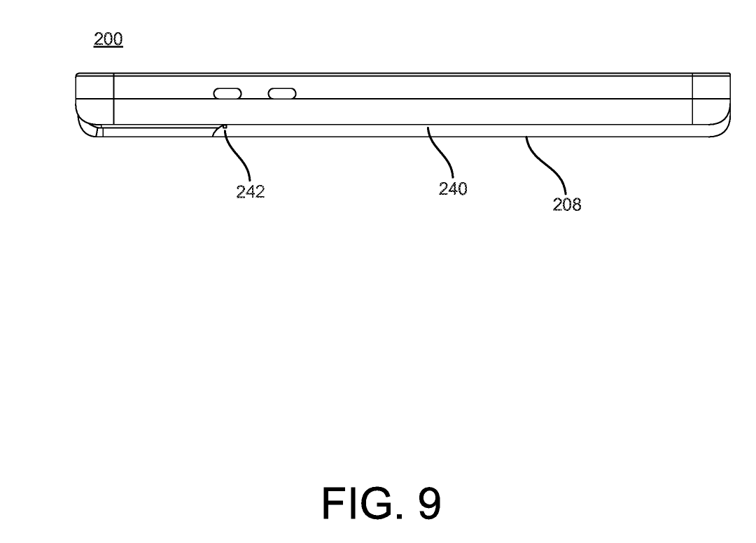

In various embodiments, a case can comprise an electrical contact or inductive charging device located at or near the distal end of an accessory berth, such as end 133 of berth 130, to provide for recharging of an inserted accessory, such as from a power cell located in the case or from a battery of a mobile electronic device inserted in the case. With reference to FIGS. 7-9, a case 200 comprising power cell 240 and electrical circuits 241 is illustrated. Power cell 240 can be embedded, for example, in rear wall of case 200 to produce a back wall rear surface 208 that is substantially flush with a rear surface of housing defining accessory berth 230. Electrical circuits can be embedded in the case material or located on a surface of the case, such as on a surface of the front compartment. In various embodiments, electrical circuits can, for example, connect a mobile device interface or external interface of the case with an electrical system component such as an accessory charging interface located at or near the accessory berth, for example, a contact 242 located at or near end 233 of accessory berth 230. In various embodiments, a case can comprise one or more charge level indicators such as charge level indicator 243. A charge level indicator can be configured to show the charge level of one of a rechargeable power cell and an accessory inserted into accessory berth 230 and in electrical contact with contact 242. A case can comprise a button 244 configured to control a switch in electrical circuits 241. Button 244 and an associated switch can be configured to enable a user to control an electrical connection, such as an electrical connection between power cell 240 and a mobile electronic device inserted into the case, or between power cell 240 and an accessory inserted into accessory berth 230, or between a mobile device and an accessory. Other configurations are possible and will be readily appreciated by a person of ordinary skill in the art; these are also within the scope of the present disclosure, for example, cases comprising electrical circuits that connect a power cell embedded in a wall of the case.

In accordance with various embodiments of the present disclosure, a case can be constructed from a moldable resilient thermoplastic material of which many such plastics are well known, including but not limited to polyethylene, polypropylene, ABS (acrylonitrile butadiene styrene), polycarbonates, PVC (polyvinyl chloride) and others well known in the art of thermoplastics. In various embodiments, a case is configured to be constructed by injection molding to produce an integrally formed case.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element or component in the present disclosure is intended to be dedicated to the public regardless of whether the element or component step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A mobile device case comprising:
a first case portion comprising:
a plurality of walls, the plurality of walls comprising a back wall, a bottom wall, a first side wall, and a second side wall;
wherein the plurality of walls define a front compartment configured to receive a mobile electronic device, and
wherein the back wall defines a back wall rear surface;
a second case portion comprising:
a plurality of surfaces, the plurality of surfaces comprising a rear surface, a front surface, a bottom surface, a first side surface, a second side surface, and a top surface, the plurality of surfaces defining an accessory berth area; and
an accessory berth defined by the mobile device case and configured to receive an accessory, wherein the accessory berth is at least partially located within the accessory berth area;
wherein a long dimension of the mobile device case defines a case axis.

2. The mobile device case of claim 1, wherein the accessory comprises:
an elongated stem with a first end and a second end, the elongated stem defining a longitudinal axis; and
a speaker portion, wherein the speaker portion is attached to the elongated stem at the first end.

3. The mobile device case of claim 2, wherein the accessory berth comprises:
a stem-receiving portion configured to receive the elongated stem; and
a speaker-receiving portion configured to receive the speaker portion.

4. The mobile device case of claim 3, wherein the accessory berth is configured to slidably receive the accessory by insertion of the accessory in a direction substantially aligned with the case axis.

5. The mobile device case of claim 4, wherein the top surface comprises an accessory berth opening, and wherein an orientation of the stem-receiving portion is substantially aligned with the case axis.

6. The mobile device case of claim 5, wherein the stem-receiving portion at least partially overlaps with the back wall of the first case portion.

7. The mobile device case of claim 6, wherein the stem-receiving portion partially protrudes beyond the back wall rear surface.

8. The mobile device case of claim 7, wherein the speaker-receiving portion is located in the accessory berth area.

9. The mobile device case of claim 7, wherein the stem-receiving portion comprises an ejection aperture adjacent to a distal end of the stem-receiving portion.

10. The mobile device case of claim 5, wherein the stem-receiving portion at least partially overlaps one of the first side wall and the second side wall of the first case portion.

11. The mobile device case of claim 3, wherein at least one of the first side surface and the second side surface comprises an accessory berth opening, and wherein the accessory berth is configured to slidably receive the accessory by insertion of the accessory in a direction substantially perpendicular to the case axis.

12. The mobile device case of claim 10, wherein the accessory berth is located in the accessory berth area, and wherein the accessory berth does not overlap the bottom wall, the first side wall, or the second side wall of the first case portion.

13. The mobile device case of claim 6, wherein the stem-receiving portion does not protrude from the back wall rear surface.

14. The mobile device case of claim 13, wherein a depression is defined in the back wall rear surface, and wherein an ejection aperture is located within the depression.

15. The mobile device case of claim 1, wherein at least a portion of the first case portion and the second case portion are integrally formed.

16. The mobile device case of claim 1, wherein the mobile device case is configured to be integrally formed by injection molding.

17. A mobile device case comprising:
a front compartment configured to receive a mobile device,
an accessory berth configured to receive a mobile device accessory, and
a charging system comprising at least one of:
a rechargeable power cell, wherein the rechargeable power cell is embedded in a wall of the mobile device case,
a mobile device interface configured to electrically couple the mobile device to the charging system,
an accessory charging interface configured to electrically couple the mobile device accessory inserted into the accessory berth to the charging system,
an external interface configured to electrically couple the charging system and an external power source, and
electronic circuitry configured to electrically couple the rechargeable power cell and at least one of the mobile device interface, the accessory charging interface, and the external interface.

18. The mobile device case of claim 17, further comprising an accessory berth aperture, wherein the accessory berth aperture is substantially hidden from view when the mobile device case is viewed from a front perspective.

19. The mobile device case of claim 17, further comprising a charge level indicator.

20. The mobile device case of claim 17, further comprising a switch and a button, wherein the switch is configured as a component of the electronic circuitry, and wherein the button is configured to control the switch.
